(19) United States
(12) Patent Application Publication
(10) Pub. No.: US 2018/0076497 A1
(43) Pub. Date: Mar. 15, 2018

(54) WAVEGUIDE FILTER

(71) Applicant: KMW INC., Hwaseong-si (KR)

(72) Inventor: In-Ho NA, Seongnam-si (KR)

(73) Assignee: KMW INC.

(21) Appl. No.: 15/818,692

(22) Filed: Nov. 20, 2017

Related U.S. Application Data
(63) Continuation of application No. PCT/KR2016/001056, filed on Feb. 1, 2016.

(30) Foreign Application Priority Data
May 21, 2015 (KR) 10-2015-0071283

(51) Int. Cl. H01P 1/208; H01P 7/06

(52) U.S. Cl. CPC H01P 1/208; H01P 7/06

(57) ABSTRACT

The present disclosure provides a waveguide filter including a casing configured to form a waveguide having a side wall formed at least partially with a through hole region, a plurality of partitions configured to form resonance sections by partitioning an interior of the waveguide within the casing, a fitting configured to have a body section that is fitted with the through hole region of the casing so as to define at least a part of an inner region of the waveguide, and to have a head section formed to correspond to at least a partial peripheral region around the through hole region of the casing so that the head section is coupled with the casing, and at least one tuning sheet configured to be held interposed between the head section of the fitting and the casing when coupled.

### TECHNICAL FIELD

The present disclosure in some embodiments relates to a radio frequency filter used in a radio communication system. More particularly, the present disclosure relates to a waveguide filter.

### BACKGROUND

The recent rapid development of mobile communication systems and mobile communication terminals has brought a surge of data amount requested from the user side. This requires the mobile communication system to take more bandwidth from limited frequency resources, while such limitation has been addressed by an emerging technology that utilizes millimeter waves having wavelengths on the order of millimeters. The next-generation 5G system which has been discussed recently actually plans to employ a small cell backhaul system utilizing millimeter waves with frequency of, for example, 28 GHz or 60 GHz.

Processing of the millimeter waves requires waveguide filters which have been mainly used in technical fields such as defense industry and satellite communications. Furthermore, in a mobile communication system, a waveguide filter of a cavity type is used so as to be able to satisfy the requirements for high band and high performance filtering characteristics.

A waveguide filter is a filter that utilizes a resonance phenomenon due to the very structure of the waveguide, and the tubular waveguide is designed to have a length corresponding to its filtering frequency characteristic. For example, a waveguide filter may be distinguished by a cavity type using a metal block and a type having a waveguide inserted with a dielectric resonance element such as ceramic, of which the cavity type waveguide filter with less dielectric loss is more suitable for higher bands such as millimeter waves.

FIG. 1 is an exploded perspective view showing an example of a typical cavity type waveguide filter (main part). Referring to FIG. 1, a cavity type waveguide filter generally includes a first case 10 (e.g., a housing) and a second case 11 (e.g., a cover) as basic components. A plurality of partitions 131, 132, 133, 134, 135, 136, 137, 138 is also provided for implementing the interior of the waveguide in accordance with the relevant filtering frequency.

A cavity type waveguide filter is usually composed of rectangular parallelepiped resonance stages which generate resonance at a desired frequency, and two partitions (aka, “Iris”) installed facing each other for establishing a coupling between the resonance stages. In the example of FIG. 1, the plurality of partitions 131 to 138 forms first to third resonance sections 121, 122 and 123 to be connected in a row in the waveguide. Here, the first resonance section 121 is preceded by a formation of input section 112, and the third resonance section 123 has a trailing output section 114, to provide incoming and outgoing power feeders, respectively. In addition, by appropriately designing the mutual spacing of every two partitions formed facing each other between the respectively resonance sections and the input and output sections, the amount of signal coupling between the sections is appropriately set.

In the above-described waveguide filter, the cross-sectional shape of the waveguide is rectangular (square or rectangular) in some typical cases, where the transverse (a) and vertical (b) lengths of the internal cross section of the waveguide influence the cutoff frequency characteristics of the relevant filter, and they can be designed into virtually normalized numerical values according to the relevant filtering frequency. In addition, the waveguide lengths of the first to third resonance sections 121, 122 and 123 along with the input and output sections 112, 114 are appropriately set according to the wavelength of the relevant filtering frequency, to be a value such as 2/λ, 4/λ, 8/λ, and so on.

The cavity type waveguide filter as shown in FIG. 1 has a structure in which, for example, the first to third resonance sections 121, 122 and 123 are connected to each other in a row, that is a 3-stage filter structure on one surface. It will be understood by those skilled in the art that the filter may be designed with four or more stages or one or two stages depending on the number of resonance sections connected to each other in a row.

An example of such a cavity type waveguide filter is disclosed in U.S. Patent Publication No. 2003/0206082 (entitled “WAVEGUIDE FILTER WITH REDUCED HARMONICS,” inventors: “Ming Hui Chen,” “Wei-Tse Cheng,” Publication Date: Nov. 6, 2003).

Meanwhile, the first case 10 and the second case 11, as shown in FIG. 1, forming the waveguide in the cavity type waveguide filter may be put to a cutting processing to provide a higher precision machining. At this time, the first case 10 and the plurality of partitions 131-138 are integrally formed from a single base material by machining. The first case 10 and the second case 11 may then be joined together by screw fastening or welding.

In order to compensate for machining tolerance in a waveguide filter having such a structure, it is common to employ a structure in which a frequency tuning screw or bar is inserted into a resonance section of the resonance structure at an appropriate place via, for example, a screw hole or the like formed in the second case 11. Likewise, each two paired partitions installed between the resonance sections may be structured to have tuning screws and bars for tuning the coupling between the resonance sections by inserting them into a screw hole or the like formed in the second case 11.

When implementing a waveguide filter for processing millimeter waves, the very short length of the frequency wavelength for processing requires the overall resonance structure to be sized very small and each two paired partitions installed between the resonance sections to be very closely spaced. This makes it difficult in practice to employ a structure that installs the aforementioned frequency tuning screws and the coupling tuning screws. For example, the distance between two partitions that are installed in pairs between the resonance sections may be less than 1 mm which is too small to actually place a tuning screw.

Thus, the difficulty to employ a structure that involves a tuning screw installation when implementing a waveguide filter for processing millimeter waves compels manufacturers to become reliant on a highly accurate manufacturing process to have such machining tolerance that does not require a tuning work. In other words, implementing a waveguide filter for processing millimeter waves requires extremely high processing accuracy in order to realize the designed structure into an actual product. For example, the machining tolerance of about 0.01 mm or less may be required at the interval between each two paired partitions facing each other.

However, the requirement of very precise machining tolerances aggravates the difficulty of machining work and lengthens the machining time, which results in an increase in machining costs, decreased production yield to render mass production difficult. For the purpose of reducing the processing cost, it is the current practice to reduce the performance of a corresponding filter, or to select and use a filter product that satisfies the required performance after producing a plurality of filters (that is, a product which does not satisfy the required performance is treated as defective one). This has set the very high market price of high performance waveguide filters.

### DISCLOSURE

### Technical Problem

The present disclosure in some embodiments seeks to provide a waveguide filter of a cavity type for enabling or facilitating tuning work for compensating for machining tolerances even in a miniaturized filter structure for processing millimeter waves.

In addition, the present disclosure in some embodiments seeks to provide a waveguide filter of a cavity type which can maintain high performance while minimizing high-precision machining work even in a miniaturized filter structure for processing different millimeter waves, thereby reducing processing cost and improving yield.

### Summary

In order to achieve the above objects, the present disclosure provides a waveguide filter including a casing, a plurality of partitions, a plug structure or fitting, and at least one tuning sheet. The casing is configured to form a waveguide having a side wall formed at least partially with a through hole region. The plurality of partitions is configured to form resonance sections by partitioning an interior of the waveguide within the casing. The fitting is configured to have a body section that is fitted with the through hole region of the casing so as to define at least a part of an inner region of the waveguide, and to have a head section formed to correspond to at least a partial peripheral region around the through hole region of the casing so that the head section is coupled with the casing. The at least one tuning sheet is configured to be held interposed between the head section of the fitting and the casing when coupled.

At least some of the plurality of partitions may be formed integrally with the body section of the fitting.

The casing may be configured to have multiples of the through hole region, which are provided with multiples of the fitting and multiples of the tuning sheet respectively by a number corresponding to the multiples of the through hole region.

### Advantageous Effects

As described above, the cavity-type waveguide filter according to some embodiments of present disclosure enables or facilitates tuning work for compensating for machining tolerances even in a miniaturized filter structure for processing millimeter waves, thereby providing further miniaturized filter products. Additionally, the cavity-type waveguide filter can maintain high performance while minimizing high-precision machining work, resulting in reduced processing cost and improved yield.

### BRIEF DESCRIPTION OF THE DRAWINGS

FIG. 1 is an exploded perspective view of an example of a typical cavity-type waveguide filter.

FIG. 2 is an exploded perspective view of a waveguide filter according to a first embodiment of the present disclosure.

FIG. 3 is an exploded perspective view of a waveguide filter according to a second embodiment of the present disclosure.

FIG. 4 is an exploded perspective view of a waveguide filter according to a third embodiment of the present disclosure.

FIG. 5 is an exploded perspective view of a waveguide filter according to a fourth embodiment of the present disclosure.

FIG. 6 is an exploded perspective view of a waveguide filter according to a fifth embodiment of the present disclosure.

### DETAILED DESCRIPTION

Preferred embodiments of the present disclosure will now be described in detail with reference to the accompanying drawings. For the sake of convenience of explanation, the sizes and shapes thereof are somewhat simplified or partly exaggerated in the attached drawings.

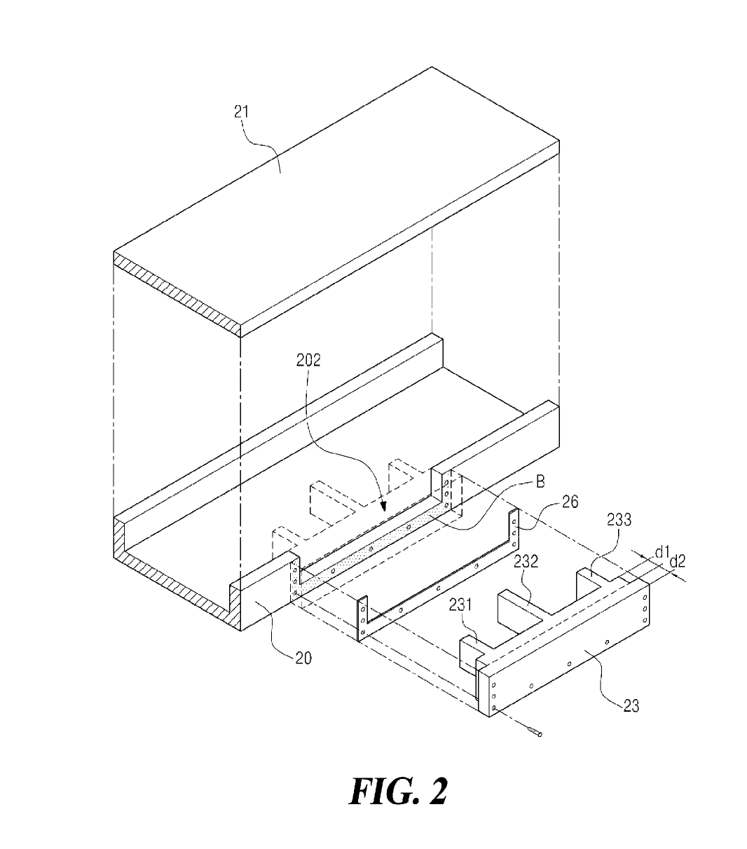

FIG. 2 is an exploded perspective view of a main part of the waveguide filter according to the first embodiment of the present disclosure. Referring to FIG. 2, the cavity-type waveguide filter according to the first embodiment of the present disclosure is basically provided with a first case 20 (e.g., housing) and a second case 21 (e.g., cover) as elements of a casing for making a waveguide, and also provided with a plurality of partitions 231, 232, 233 configured to form one or more resonance sections by partitioning the inside of the waveguide within the casing according to the corresponding filtering frequency characteristic.

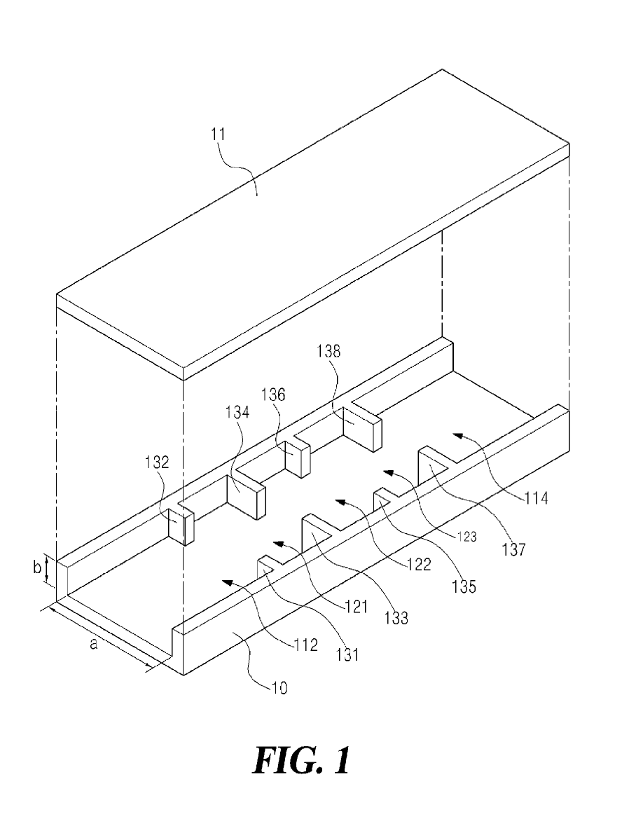

However, in the example of FIG. 2, the multiple partitions 231-233 are illustrated as they are installed not to be paired facing each other between the resonance sections but disposed one by one on one side. In this case, one of the partitions 231, 232, 233, for example, is a substitute for each pair of partitions in the structure shown in FIG. 1, and the spacing of the coupling regions formed between the resonance sections by one of the partitions 231, 232, 233 may be designed to correspond to the spacing of the coupling regions formed by the partitions in paired arrangement, for example, as shown in FIG. 1.

The casing, which is formed with the first case 20 and the second case 21 assembled, has a side wall formed at least partially (in the example of FIG. 2, at the side wall part of the second case 21) with a through hole region 202 through which an external fitting 23 may be inserted by press fitting its body section d1. The fitting 23 is formed in such a structure that its corresponding body section d1 is detachably inserted in the through hole region 202 formed in the casing. At least some (all in the example of FIG. 2) of the plurality of partitions 231 to 233 are arranged so as to be fixed to the body section of the fitting 23 or are formed integrated with the body of the fitting 23. The fitting 23 has a head (d2) section formed so as to correspond to at least a partial peripheral region (dot shaded area B in FIG. 2) around the through hole region 202 of the casing, and the fitting 23 may be configured to be coupled with the casing by a screw fastening method.

The above structure may be seen that at least some of the side wall of the casing is configured to be detachable to form the body section d1 of the fitting 23. In addition, such a structure may be seen that the body d1 of the fitting 23 defines a portion corresponding to one side in at least a part of a region of the waveguide having a rectangular cross section.

Further, the present disclosure features a very thin conductive tuning sheet 26 that is inserted between the head (d2 in FIG. 2) section of the fitting 23 and the mating area of corresponding casing, that is, at least a partial peripheral region B around the through hole region 202 of the casing, and it is joined to the casing together with the fitting 23. For example, the head (d2) section of the fitting 23 and the tuning sheet 26 are formed with a plurality of screw fastening holes at corresponding positions therein, where appropriate, with a plurality of screw holes being formed at corresponding positions in the casing. In addition, multiple fastening screws are respectively fastened to the plurality of screw holes formed in the casing through the plurality of screw holes formed in the head (d2) section of the fitting 23 and the tuning sheet 26.

The tuning sheet 26 is structured for tuning the coupling between the resonance sections, and the placement of the tuning sheet 26 in between the fitting 23 and the casing results in such tuning that further widens the spacing of the coupling region formed between the resonant sections by the plurality of partitions 231 to 233. The tuning sheet 26 in such arrangement may be formed to have a thickness of, for example, about 0.01 mm or less. At this time, multiples of the tuning sheet 26 may be inserted to compensate for the spacing deviation of the coupling region, or various types of tuning sheets having different thicknesses (and/or different materials) may be prepared in advance for installing them each or in combination.

As described above, the waveguide filter according to the first embodiment of the disclosure shown in FIG. 1 is configured so that it is subject to a design process for forming the partitions 231 to 233 which are the internal coupling structure only on one side surface, and a subsequent process for separately machining the coupling structure formation and assembling the same into the waveguide filter. At this time, the conductive tuning sheet 26 having an appropriate thickness is inserted and coassembled on the surface to which the coupling structure is fastened, to compensate for the spacing deviation of the coupling region due to the possible machining tolerance.

This remarkably simplifies the processing time of the casing and so reduces the processing time and processing cost. Further, this obviates the need for machining the fitting 23 with relatively high precision machining tolerance, and the resultant machining tolerances are such that the thickness of the tuning sheet 26 can be used to compensate for the spacing deviation of the coupling region due to machining tolerance. In this case, varying the number of tuning sheets 26 to be fastened or changing the type thereof alone can compensate for machining tolerances and a lot deviation, leading to greatly increased production yield. This works advantageously for mass production, and it can strengthen price competitiveness. In addition, it can reduce the time for coupling tuning, to effect a reduction of labor costs.

Besides, by changing only the configuration (for example, size, shape, interval, etc.) of the fitting 33 and the partitions formed in the fitting 33 in the same frequency band, filters can be easily implemented with various different filtering characteristics.

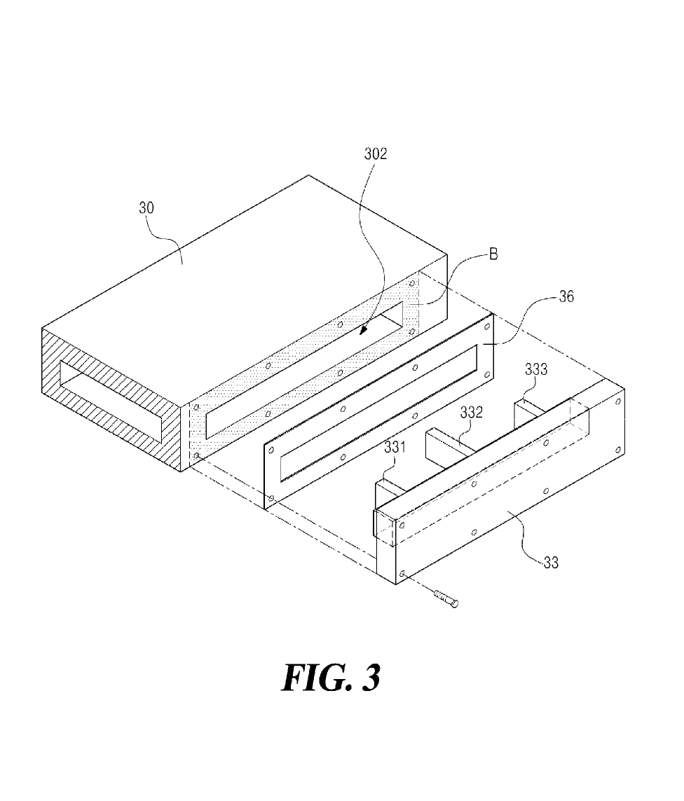

FIG. 3 is an exploded perspective view of a waveguide filter according to a second embodiment of the present disclosure. Referring to FIG. 3, the cavity type waveguide filter according to the second embodiment of the present disclosure, like the structure of the first embodiment shown in FIG. 2, has a casing 30 for forming a waveguide, and multiple partitions 331, 332 and 333 adapted to form resonant sections by dividing the waveguide inside the casing 30 in accordance with the corresponding filtering frequency characteristics. As in the first embodiment shown in FIG. 2, some of the side wall of the casing 30 is provided with a through hole area 302 for receiving a body section of an external fitting 33 when it is inserted. On the body section of the fitting 33, a plurality of partitions 331 to 333 is integrally formed. A tuning sheet 36 for coupling tuning is inserted between a head section of the fitting 33 and at least a partial peripheral region (dot shaded area B in FIG. 3) around the through hole region 302 of the casing 30, wherein the fitting 33 and the tuning sheet 36 may be configured to be coupled to the casing 30 by a screw fastening method.

The casing 30 of the waveguide filter according to the second embodiment shown in FIG. 3 is structurally different from the first embodiment shown in FIG. 2 where the relevant casing is completed after combining the first and second component cases that are separately manufactured, in that the casing 30 of the second embodiment is integrally formed as a tubular structure through machining or die processing a single base material. This is because some embodiments of the present disclosure wherein the partition structure is formed in a separate fitting member, obviate the need for an extra machining to form the partition structure inside the casing 30.

In this way, fabricating a filter with the structure of the second embodiment shown in FIG. 3 remarkably facilitates the manufacture of the casing and reduces the processing deviations when machining the interior of the waveguide in the casing.

Structurally compared with the first embodiment shown in FIG. 1, the casing 30 of the second embodiment shown in FIG. 3 is formed to be thicker as the fitting 33 is formed to be thicker. Such a structure makes the manufacturing easier, for example, facilitating to configure a screw fastening structure for coupling the fitting 33 and the tuning seat 36 to the casing 30. In this case, it shall be understood that the internal waveguide structure of the actual corresponding filter may stay the same across the embodiments and that the accompanying filtering characteristic remains unchanged.

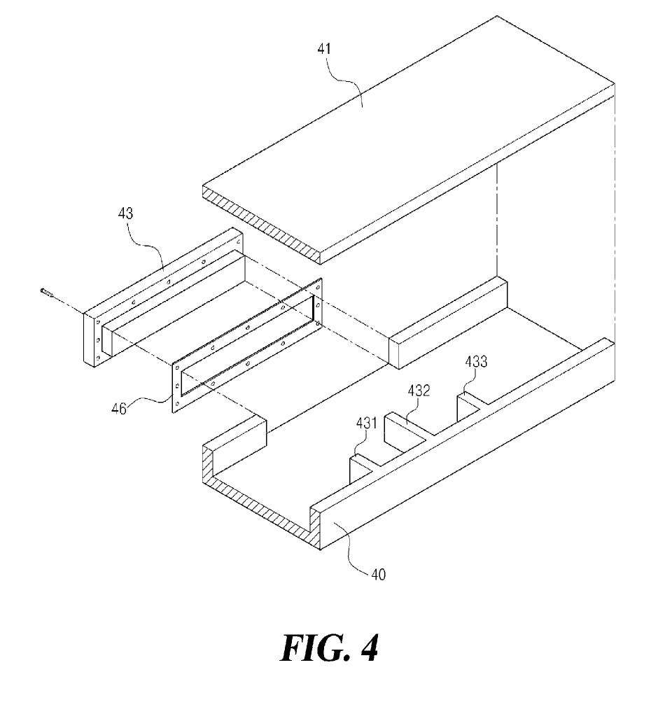

FIG. 4 is an exploded perspective view of a waveguide filter according to a third embodiment of the present disclosure. Referring to FIG. 4, the cavity type waveguide filter according to the third embodiment of the present disclosure is similar to the structure of the first embodiment shown in FIG. 2, in that it has a first case 40 and a second case 41 for forming a waveguide, and multiple partitions 431, 432 and 433 adapted to form resonant sections by dividing the waveguide inside the casing in accordance with the corresponding filtering frequency characteristics. As in the second embodiment shown in FIG. 2, some of the side walls of the casing 40, 41 is provided with a through hole area for receiving a body section of an external fitting 43 as it is inserted. A tuning sheet 46 for tuning the coupling is inserted between a head section of the fitting 43 and the casing 40, 41, wherein the fitting 43 and the tuning sheet 46 may be configured to be coupled to the casing 40, 41 by a screw fastening method.

The waveguide filter according to the third embodiment illustrated in FIG. 4 is structurally different from the first embodiment shown in FIG. 2 in that the multiple partitions 431, 432 and 433 are formed not in the head section of the fitting 43 but in the case 30 on its side opposite to the side where the fitting 43 is inserted. It shall be understood that this embodiment may share the internal waveguide structure of the actual filter with other embodiments and that the accompanying filtering characteristic is consistent.

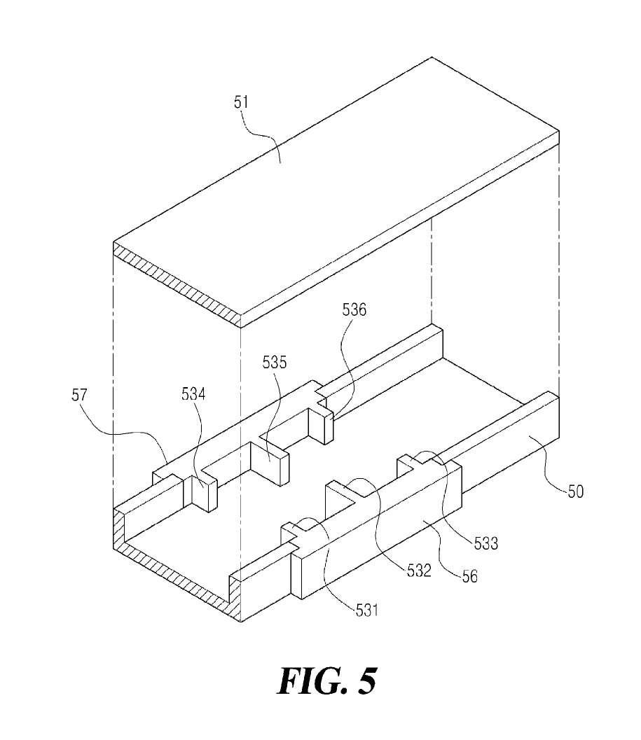

FIG. 5 is an exploded perspective view of a waveguide filter according to a fourth embodiment of the present disclosure. Referring to FIG. 5, the cavity type waveguide filter according to the fourth embodiment of the present disclosure is similar to the structure of the first embodiment shown in FIG. 2, and it has a first case 50 and a second case 51 for jointly forming a waveguide, and a plurality of partitions 531, 532, 533, 534, 535, 536 which forms resonance sections by dividing the interior of the waveguide in the casing according to the corresponding filtering frequency characteristic.

In the fourth embodiment shown in FIG. 5, the waveguide filter is provided with two individual through holes formed on opposite sides of the casing 50, 51, and first and second external fittings 56, 57 having their body sections fitted into the two through holes. Of the plurality of partitions 531, 532, 533, 534, 535, 536, the first to third partitions 531-533 may be formed on the first fitting 56, and the fourth to sixth partitions 534-536 may be formed on the second fitting 57.

This provides a structure in which opposing partitions are formed in pairs in the resonance sections, and it can be seen that it is configured to perform tuning of the coupling from the opposite sides.

It should be understood that tuning sheets (not shown) for tuning the coupling are inserted between head sections of the first and second fittings 56, 57 and the case 50, wherein the first and second fittings 56, 57 and the tuning sheets may be configured to be coupled to the case 50 by a screw fastening method.

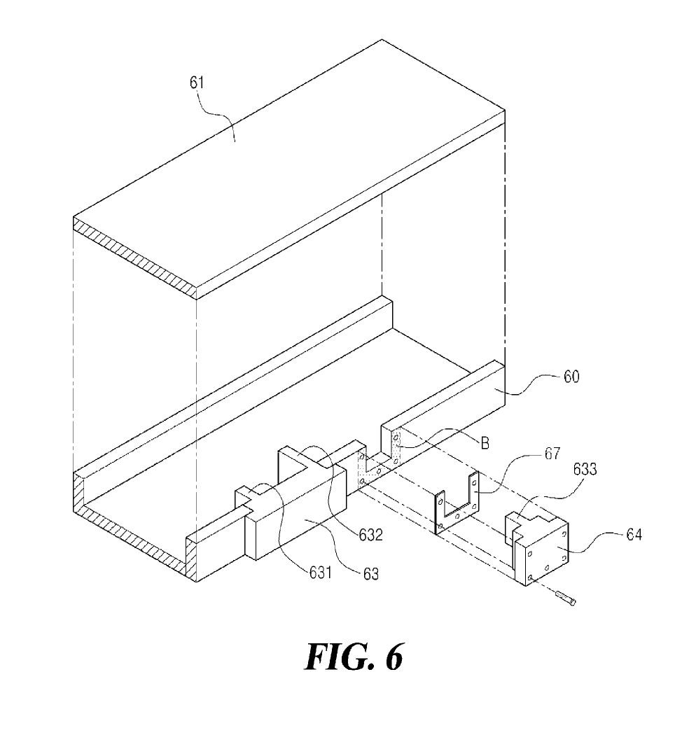

FIG. 6 is an exploded perspective view of a waveguide filter according to a fifth embodiment of the present disclosure. Referring to FIG. 6, the cavity type waveguide filter according to the fifth embodiment of the present disclosure is similar to the structure of the first embodiment shown in FIG. 2, and it has a first case 60 and a second case 61 for jointly forming a waveguide, and a plurality of partitions 631, 632, 633 which forms resonance sections by dividing the interior of the waveguide in the casing according to the corresponding filtering frequency characteristic.

In the fifth embodiment shown in FIG. 6, the waveguide filter is provided with two individual through holes formed on one side of the casing 60, 61, and first and second external fittings 63, 64 having their body sections fitted into the two through holes. Of the plurality of partitions 631, 632, 633, the first and second partitions 631, 632 may be formed on the first fitting 63, and the third partition 534-536 may be formed on the second fitting 64.

This structure is configured to allow coupling tuning to be carried out individually at multiple locations on one side in the waveguide.

FIG. 6 also illustrates that a tuning sheet 67 for coupling tuning is inserted between a head section of the second fitting 64 and the case 60, and likewise a tuning sheet is inserted between the first fitting 63 and the case 60.

The waveguide filter of the cavity type according to some embodiments of the present disclosure may be constructed as described above, while the present disclosure may have various other embodiments and modifications. For example, it can be seen that the number of resonance sections in each of the filter structures described above can be variously designed as necessary.

In the fourth embodiment of FIG. 5, both of the first and second fittings 56, 57 are illustrated with partition formations, although the partitions may be formed on one of the first and second fittings 56, 57 to work quite well.

In the illustrated embodiments, the fittings and the tuning sheets are detachably installed on the left side and/or the right side of the casing (on the drawing), but the upper side and/or the lower side of the casing may also be configured to install the same in a detachable manner.

As described above, various modifications and changes of the present disclosure are possible, and therefore the scope of the present disclosure is not to be limited by the explicitly described above embodiments but to be defined by the claims and equivalents thereof.

1. A waveguide filter, comprising:
a casing configured to form a waveguide having a side wall formed at least partially with a through hole region;
a plurality of partitions configured to form resonance sections by partitioning an interior of the waveguide within the casing;
a fitting configured to have a body section that is fitted with the through hole region of the casing so as to define at least a part of an inner region of the waveguide, and to have a head section formed to correspond to at least a partial peripheral region around the through hole region of the casing so that the head section is coupled with the casing; and
at least one tuning sheet configured to be held interposed between the head section of the fitting and the casing when coupled.

2. The waveguide filter according to claim 1, wherein at least some of the plurality of partitions are integrally formed with the body section of the fitting.

3. The waveguide filter according to claim 2, wherein the tuning sheet has a thickness of 0.01 mm or less.

4. The waveguide filter according to claim 1, wherein the casing is integrally formed as a tubular structure through machining a single base material.

5. The waveguide filter according to claim 1, wherein the casing is configured to have multiples of the through hole region, which are provided with multiples of the fitting and multiples of the tuning sheet respectively by a number corresponding to the multiples of the through hole region.
